(19) United States
(12) Patent Application Publication
(10) Pub. No.: US 2024/0326414 A1
(43) Pub. Date: Oct. 3, 2024

(54) LIQUID DISCHARGING SYSTEM

(71) Applicant: BROTHER KOGYO KABUSHIKI KAISHA, Nagoya (JP)

(72) Inventor: Satoru ARAKANE, Nagoya (JP)

(21) Appl. No.: 18/609,141

(22) Filed: Mar. 19, 2024

(30) Foreign Application Priority Data
Mar. 28, 2023 (JP) 2023-051728

(51) Int. Cl. B41J 2/045; B41J 2/145

(52) U.S. Cl. CPC B41J 2/04581; B41J 2/145

(57) ABSTRACT

A liquid discharging system includes a head and a controller system. The head has a first nozzle row including a first nozzle and a second nozzle row including a second nozzle. The nozzles in the first and second nozzle rows are aligned in a first direction, and the first nozzle row and the second nozzle row are arrayed along a second direction, which intersects with the first direction. The controller system is configured to control the head to discharge liquid of the same type from the first nozzle and the second nozzle at a recording medium when the first nozzle and the second nozzle are each located at a same position with respect to the recording medium while the head moves in the second direction relatively to the recording medium.

### REFERENCE TO RELATED APPLICATIONS

This application claims priority from Japanese Patent Application No. 2023-051728, filed on Mar. 28, 2023. The entire content of the priority application is incorporated herein by reference.

### BACKGROUND ART

An inkjet printer having a recording head capable of discharging inks in multiple colors is known. In the recording head, for example, a plurality of nozzles to discharge inks in multiple colors may be aligned in a sub-scanning direction in rows, and a plurality of nozzles to discharge ink in black may be aligned in the sub-scanning direction in rows. The plurality of nozzles to discharge the inks in the multiple colors may form, for example, three nozzle rows arrayed along a main-scanning direction, and the plurality of nozzles to discharge the ink in black may form, for example, three nozzle rows arrayed along the main-scanning direction. The nozzles forming the six nozzle rows may be located at positions to overlap one another in the main-scanning direction. Therefore, the inkjet printer may print an image in a speed three times faster in a monochrome printing mode than a speed to print an image in a multicolor printing mode.

### SUMMARY

While the known inkjet printer operating in the monochrome printing mode may print an image in the speed three times faster than the multicolor printing mode, a quality of the image may not be improved. In other words, the inkjet printer having the recording head, in which the plurality of nozzles forming two adjacent nozzle rows are located to overlap one another in the main scanning direction, may not necessarily improve a quality of an image printed in the monochrome printing mode.

The present disclosure relates to a liquid discharging system, which may improve a quality of an image printed therein.

According to the present disclosure, a liquid discharging system includes a head and a controller system. The head includes a first nozzle row and a second nozzle row. The first nozzle row has a plurality of nozzles including a first nozzle aligned in a first direction. The second nozzle row has a plurality of nozzles including a second nozzle aligned in the first direction. The first nozzle row and the second nozzle row are arrayed along a second direction, which intersects with the first direction. The first nozzle and the second nozzle are located at positions to overlap each other in the second direction. The controller system is configured to control the head to discharge liquid of the same type from the first nozzle and the second nozzle at a recording medium when the first nozzle and the second nozzle are each located at the same position with respect to the recording medium while the head moves in the second direction relatively to the recording medium.

According to the present disclosure, further, another liquid discharging system having a head and a controller system. The head includes a first nozzle row and a second nozzle row. The first nozzle row has a plurality of nozzles including a first nozzle aligned in a first direction. The second nozzle row has a plurality of nozzles including a second nozzle aligned in the first direction. The first nozzle row and the second nozzle row are arrayed along a second direction, which intersects with the first direction. The first nozzle and the second nozzle are located at positions to overlap each other in the second direction. The controller system is configured to receive image data including image data pieces to compose an image, of which resolution corresponding to a third direction intersecting with the second direction is equal to a product of a resolution of an image to be printed on the recording medium and the number of the nozzle rows in the head, distribute two image data pieces adjacent in the third direction among the image data pieces in the image data to the first nozzle and the second nozzle, and control the head to discharge liquid of the same type at the recording medium from the first nozzle according to one of the two image data pieces assigned to the first nozzle and from the second nozzle according to the other of the two image data pieces assigned to the second nozzle while the head moves in the second direction relatively to the recording medium.

### BRIEF DESCRIPTION OF DRAWINGS

FIG. 1 is an overall plan view of a printing system.

FIG. 2 is a cross-sectional view of a head in the printing system.

FIG. 3 is a block diagram to illustrate an electric configuration of the printing system.

FIG. 4 is a flowchart to illustrate a flow of steps to be executed in an external device in the printing system.

FIG. 5 is an illustrative view of image data pieces composing image data in first print data.

FIG. 6 is an illustrative view of image data pieces composing image data in second print data.

FIG. 7 is a flowchart to illustrate a flow of steps to be executed in a printer in the printing system.

FIG. 8 is an illustrative view of dots each formed in inks discharged from four nozzles in a near range on a sheet in a second printing process.

FIG. 9 illustrates timings to discharge ink from four nozzles while a head moves in a forward-scanning direction in a printing system.

FIG. 10 illustrates timings to discharge ink from four nozzles while the head moves in a backward-scanning direction in the printing system.

FIG. 11 is an illustrative view of dots formed on a sheet in a second printing process executed in the printing system.

FIG. 12 illustrates image data in second print data to be used in a printing system.

### DESCRIPTION

### First Embodiment

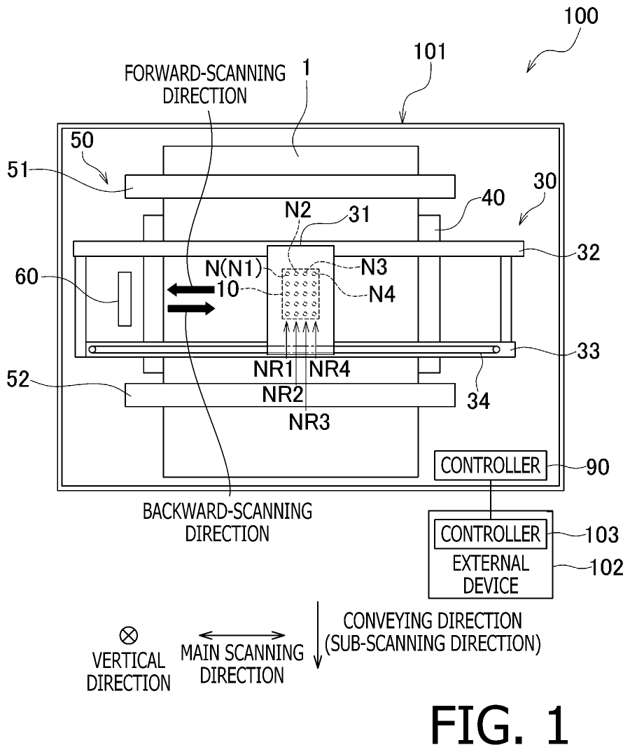

As shown in FIG. 1, a printing system 100 includes a printer 101 having a controller 90 and an external device 102. The external device 102 is connected with the controller 90 to communicate to exchange information. The printing system 100 is an example of the liquid discharging system, and the printer 101 is an example of the liquid discharging apparatus. The controller 90 will be described further below.

With reference to FIGS. 1-3, overall and detailed configurations of the printer 101 will be described. As shown in FIG. 1, the printer 101 includes a head 10 having a plurality of nozzles N formed on a downward surface, a movable assembly 30 to move the head 10 in a main scanning direction, a platen 40 to support a sheet 1 from below, a conveyer 50 to convey the sheet 1 in a conveying direction, a receiver 60 located on one side of the platen 40 in the main scanning direction, and the controller 90. The main scanning direction is a crosswise direction to a viewer of FIG. 1 and intersects orthogonally with a vertical direction. The conveying direction is a sub-scanning direction, which intersects orthogonally with the main scanning direction and with the vertical direction. The main scanning direction is an example of the second direction, and the conveying direction is an example of the first direction and the third direction.

The plurality of nozzles N form four nozzle rows NR1-NR4 arrayed along the main scanning direction. In the context below, any non-specific one(s) of the nozzle rows NR1-NR4 may be generally called a nozzle row NR. The nozzle row NR1 is an example of the first nozzle row, and any one of the nozzle rows NR2-NR4 may be an example of the second nozzle row. The nozzle rows NR1-NR4 each consist of a plurality of nozzles N aligned along the sub-scanning direction at equal intervals. Among the nozzle rows NR1-NR4, the nozzles N are located at positions to overlap one another in the main scanning direction. According to the present embodiment, two nozzles N adjacent in the sub-scanning direction among the nozzles N in the nozzle rows NR1-NR4 are spaced from each other by a distance corresponding to 300 dpi, which is a printing resolution of an image to be formed on a sheet 1 in a single scanning act. However, the distance between the nozzles N in the sub-scanning direction may not necessarily be limited but may be modified preferably. The scanning act will be described further below.

The four nozzle rows NR1-NR4 are arrayed along the main-scanning direction at equal intervals. The nozzles N forming the four nozzle rows NR1-NR4 may discharge ink in black. In other words, the printer 101 according to the present embodiment is a monochrome printer.

According to the present embodiment, each nozzle row NR consists of a plurality of nozzles N linearly aligned in the sub-scanning direction; however, the nozzles N in each nozzle row NR may not necessarily be aligned in the sub-scanning direction as long as the nozzle row NR has a plurality of nozzles N located along the sub-scanning direction. In other words, each nozzle row NR may have a plurality of nozzles N offset from one another in the main scanning direction, provided that projections of the nozzles N onto a line in the sub-scanning direction are spaced by a distance corresponding to a predetermined printing resolution. Moreover, the nozzle row NR may have a plurality of nozzles N located along a direction intersecting with the sub-scanning direction and the main scanning direction.

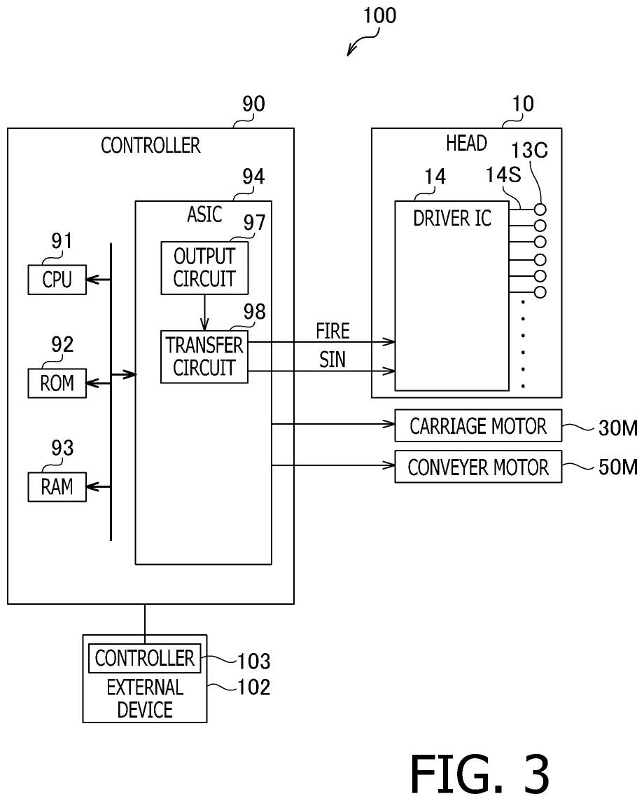

The movable assembly 30 includes a carriage 31, a pair of guides 32, 33, a belt 34, and a carriage motor 3M (see FIG. 3). The carriage 31 retains the head 10. The pair of guides 32, 33 support the carriage 31. The belt 34 is coupled to the carriage 31. The guides 32, 33 and the belt 34 extend in the main scanning direction. When the carriage motor 30M is activated under control of the controller 90, the belt 34 may circulate, and the carriage 31 may run in the main scanning direction.

The main scanning direction includes a forward-scanning direction, which is leftward in FIG. 1, and a backward-scanning direction, which is opposite to the forward-scanning direction, i.e., rightward in FIG. 1. The movable assembly 30 may move the head 10 bidirectionally in either the forward-scanning direction or the backward-scanning direction.

The platen 40 is located below the head 10. The platen 40 may support the sheet 1 on an upper surface thereof.

The conveyer 50 includes two roller pairs 51, 52 and a conveyer motor 50M (see FIG. 3). Between the roller pair 51 and the roller pair 52 in the conveying direction, the head 10 and the platen 40 are located. When the conveyer motor 50M is activated under control of the controller 90, the roller pairs 51, 52 may rotate with the sheet 1 nipped there-between, and the sheet 1 may be conveyed in the conveying direction. Thus, the conveyer 50 may move the sheet 1 relatively to the head 10.

The receiver 60 may receive the ink discharged from the nozzles N when the printer 101 performs an act called flushing. The receiver 60 is located between the guides 32, 33 in the conveying direction. The receiver 60 is located outside a conveyance area, in which the sheet 1 being conveyed by the conveyer 50 may travel, at a position adjacent the conveyance area in the main scanning direction. In a flushing process, which will be described further below, the ink may be discharged at the receiver.

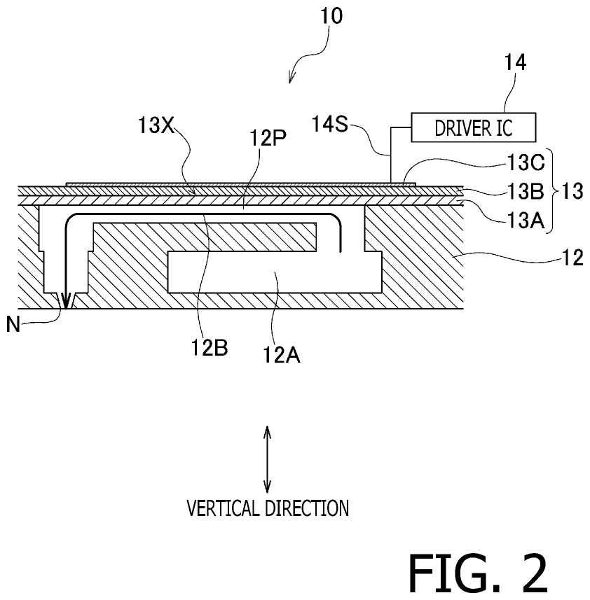

The head 10 includes, as shown in FIG. 2, a flow-path unit 12 and an actuator unit 13.

On a downward surface of the flow-path unit 12, a plurality of nozzles N (see FIG. 1) are formed. Inside the flow-path unit 12, a common flow path 12A and a plurality of individual flow paths 12B are formed. The common flow path 12A is continuous with an ink tank, which is not shown, and the plurality of individual flow paths 12B are continuous with the plurality of nozzles N in one-to-one correspondence. The individual flow paths 12B are paths connecting an exit of the common flow path 12A with the nozzles N through a plurality of pressure chambers 12P. The plurality of pressure chambers 12P are open upward on an upper side of the flow-path unit 12.

The actuator unit 13 includes a metal-made vibration board 13A, a piezoelectric layer 13B, and a plurality of individual electrodes 13C. The vibration board 13A is arranged on the upper side of the flow-path unit 12 to cover the plurality of pressure chambers 12P from above, the piezoelectric layer 13B is arranged over the vibration board 13A, and the plurality of individual electrodes 13C are arranged on an upper side of the piezoelectric layer 13B above the plurality of pressure chambers 12P in one-to-one correspondence.

The vibration board 13A and the individual electrodes 13C are electrically connected with a driver IC 14. The driver IC 14 may, on one hand, maintain potential of the vibration board 13A at a ground potential and, on the other hand, may change potentials of the individual electrodes 13C between the ground potential and a driving potential. In particular, the driver IC 14 may generate driving signals based on control signals, e.g., waveform signal FIRE and selection signal SIN, from the controller 90 and supply the driving signals to the individual electrodes 13C through signal lines 14S. Thereby, the potentials of the individual electrodes 13C may change between a predetermined driving potential (VDD) and the ground potential (0V). Accordingly, parts of the vibration board 13A and the piezoelectric layer 13B between the individual electrodes 13C and the pressure chambers 12P, i.e., actuators 13X, may deform, volumes of the pressure chambers 12P may change, pressure may be applied to the ink in the pressure chambers 12P, and the ink may be discharged from the nozzles N. The actuators 13X are provided to the individual electrodes 13C, i.e., to the nozzles N, in one-to-one correspondence, and may deform individually in response to the potentials supplied to the respective individual electrodes 13C.

The controller 90 includes, as shown in FIG. 3, a CPU 91, a ROM 92, a RAM 93, and ASIC 94. The controller 90 is an example of the controller system.

The ROM 92 stores programs and data to be used by the CPU 91 and the ASIC 94 to control the devices in the printer 101. The RAM 93 may temporarily store data, e.g., image data, to be used by the CPU 91 and the ASIC 94 to run the programs. The controller 90 is connected with the external device 102 for communication and, based on a print command output from the external device 102, the CPU 91 and the ASIC 94 may execute a printing process, which will be described further below.

In the printing process, the ASIC 94 may activate the driver IC 14, the carriage motor 30M, and the conveyer motor 50M according to commands from the CPU 91 to execute a conveying act and a scanning act based on the print command received from, for example, the external device 102. The print command may include, for example, first print data and second print data described below. In the conveying act, the sheet 1 is conveyed by the conveyer 50 by a predetermined amount in the conveying direction, and in the scanning act, the head 10 is moved in the main scanning direction and the ink is discharged from the nozzles N at the sheet 1 while the head 10 faces the sheet 1. Thereby, dots may be formed in the ink on the sheet 1, and an image consisting of the dots may be recorded.

The ASIC 94 includes, as shown in FIG. 3, an output circuit 97 and a transfer circuit 98. The output circuit 97 may generate a waveform signal FIRE and selection signal SIN and output the generated signals to the transfer circuit 98 on a printing cycle basis. The printing cycle is a time period required for the sheet 1 to move with respect to the head 10 by a unit distance corresponding to a resolution (a printing resolution) of the image to be formed on the sheet 1.

The waveform signal FIRE is a serial signal, in which four units of waveform data are serially combined. Each unit of waveform data indicates a size of a droplet of the ink, which is one of “zero (no discharging),” “small,” “medium,” and “large” having different numbers of pulses, to be discharged from the nozzle N in the single printing cycle.

The selection signal SIN is a serial signal containing selection data for selecting one of the four units of waveform data. The selection signal SIN is generated for each of the actuators 13X and for each printing cycle based on the image data contained in the print command.

The transfer circuit 98 may transfer the waveform signal FIRE and the selection signal SIN received from the output circuit 97 to the driver IC 14. The transfer circuit 98 incorporates an LVDS (low voltage differential signaling) driver corresponding to the waveform signal FIRE and the selection signal SIN and may transfer the waveform signal FIRE and the selection signal SIN to the driver IC 14 as pulse-formed differential signals.

The ASIC 94 may, in the printing process, control the driver IC 14 to generate driving signals based on the waveform signal FIRE and the selection signal SIN for each pixel and supply the generated driving signals to the individual electrodes 13C through the signal lines 14S. Thereby, the ASIC 94 may cause the ink to be discharged from each of the nozzles N in the size selected among the four droplet sizes, which are zero, small, medium, and large, at the sheet 1.

The ASIC 94 is connected electrically with the driver IC 14, the carriage motor 30M, and the conveyer motor 50M.

The external device 102 may be, for example, a personal computer (PC) and includes a controller 103 to control overall activities of the external device 102. The controller 103 is connected with the controller 90 in the printer 101. Further, the controller 103 has a CPU, a ROM, a RAM, an ASIC, and a flash memory, which are not shown but may function similarly to those in the controller 90.

### Printing Control

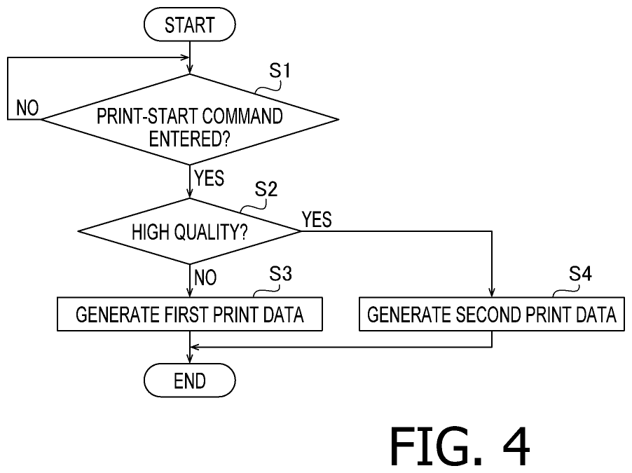

Next, a flow of control over the printing system 100 for printing an image on the sheet 1 will be described. In the present embodiment, a flow of control for printing a plain image in resolutions of 600 dpi in the main scanning direction and 300 dpi in the sub-scanning direction on the sheet 1 will be described. Optionally, the resolutions may be changed. The controller 103 may execute a process according to the flowchart shown in FIG. 4 when a user inputs a print-start command, which may cause the printer 101 to print an image on the sheet 1, through an input interface (not shown). The print-start command may be entered by, for example, the user selecting a print-start button, which may cause the printer 101 to start printing and may be displayed in a display device (not shown) of the external device 102.

In particular, as shown in FIG. 4, the controller 103 determines whether the print-start command is entered (S1). If the print-start command is not entered (S1: NO), the controller 103 repeats S1. If the print-start command is entered (S1: YES), the controller 103 determines whether a designated printing mode is a high-quality mode or a regular mode (S2). According to the present embodiment, the printing mode includes the high-quality mode and the regular mode. The high-quality mode is an operation mode, in which a quality of an image to be printed on the sheet 1 is higher than an image to be printed in the regular mode.

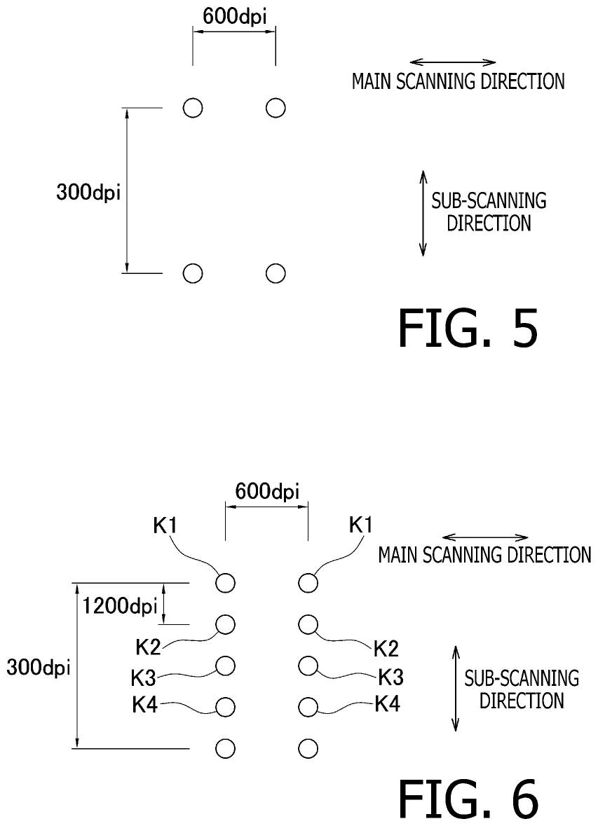

If the printing mode selected by the user through the input interface is the regular mode (S2: NO), the controller 103 generates first print data (S3). On the other hand, if the printing mode selected by the user is the high-quality mode (S2: YES), the controller 103 generates second print data (S4). The first print data includes image data that may cause the printer 101 to discharge the ink in a desired droplet size from the nozzles N and is generated according to a size of the image to be printed currently. According to the present embodiment, the image data included in the first print data indicates that the droplet size of the ink to be discharged is large, which is an example of the first amount. FIG. 5 illustrates the image data including a plurality of image data pieces to compose an image in the exemplary resolutions of 600 dpi in the main scanning direction and in 300 dpi in the sub-scanning direction. Circles in FIG. 5 each represent one of the image data pieces corresponding to a pixel to form the image being printed.

The second print data includes image data that may cause the printer 101 to discharge the ink in a desired droplet size from the nozzles N and is generated according to a size of the image being printed currently. According to the present embodiment, the image data included in the second print data indicates that the droplet size of the ink to be discharged is small, which is an example of the second amount. The image data in the second print data is image data to compose an image, of which resolution in the sub-scanning direction is equal to a product of the printing resolution in the sub-scanning direction, i.e., 300 dpi, and the number of nozzle rows NR having the nozzles N that may discharge the ink at the sheet 1 when the nozzles N are each located at the same position with respect to the sheet 1. According to the present embodiment, for example, a number of nozzle rows NR1-NR4 having the nozzles N to discharge the ink at the sheet 1 is four; therefore, image data composing an image in a resolution of 1200 dpi in the sub-scanning direction, which is the printing resolution 300 dpi multiplied by 4, is generated. FIG. 6 illustrates the image data including a plurality of image data pieces to compose an image in the resolutions of 600 dpi in the main scanning direction and 1200 dpi in the sub-scanning direction. Circles in FIG. 6 each represent one of the image data pieces corresponding to a pixel to form the image being printed. For another example, in a case where the number of the nozzle rows NR having the nozzles N that may discharge the ink is two or three, image data composing an image, of which resolution in the sub-scanning direction is equal to the printing resolution multiplied by 2 or 3, may be generated. Optionally, the image data in the first print data and the second print data may each compose an image in any resolutions depending on an arrangement of the nozzles N in the head 10.

### Printing Process

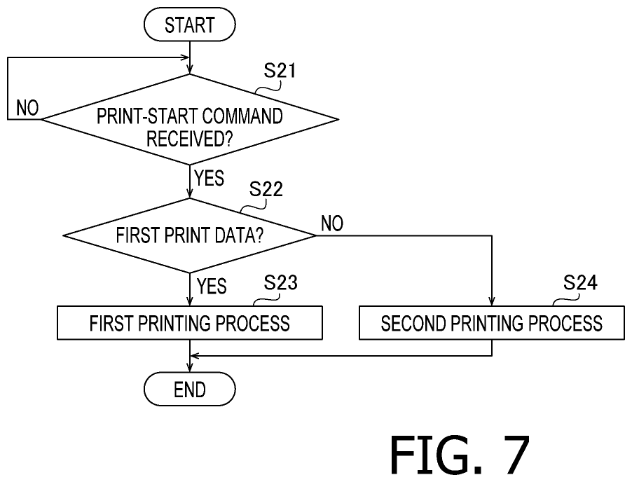

Next, a printing process will be described with reference to FIG. 7. The controller 90 in the printer 101 may execute the printing process according to the flowchart shown in FIG. 7 when a print command, which is one of the first print data and the second print data, is received from the external device 102.

The controller 90 determines whether the print command is received (S21). If the print command is not received (S21: NO), the controller 90 repeats S21. If the print command is received (S21: YES), the process proceeds to S22.

In S22, the controller 90 determines whether the received print command is the first print data. If the received print command is the first print data (S22: YES), the controller 90 executes a first printing process (S23). The first printing process executed based on the first print data is a printing process operated in the regular mode. On the other hand, a second printing process executed based on the second print data is a printing process operated in the high-quality mode.

In the first printing process, the controller 90 repeats a first discharge-scanning act being a single run of the head 10 to scan in either the forward-scanning direction or the backward scanning direction based on the received first print data and a conveying act to convey the sheet 1 in the sub-scanning direction alternately to print an image. In the first discharge-scanning act, the controller 90 controls the head 10 to discharge the ink in the large droplet size from the nozzles N that form one of the four nozzle rows NR1-NR4 based on the image data in the first print data. In the conveying act executed between the first discharge-scanning acts, the controller 90 controls the conveyer 50 to convey the sheet 1 by a distance, which is equal to a distance of separation between two of the nozzles N located on one end and the other end in the sub-scanning direction among the nozzles N forming the nozzle row NR.

In S22, on the other hand, if the received print command is the second print data (S22: NO), the controller 90 executes the second printing process (S24).

In the second printing process, first, the controller 90 executes a distributing process. Thereafter, the controller 90 repeats a second discharge-scanning act being a single run of the head 10 to scan in either the forward-scanning direction or the backward scanning direction based on the received second print data and a conveying act to convey the sheet 1 in the sub-scanning direction alternately to print an image. In the conveying act executed between the second discharge-scanning acts, similarly to the conveying act executed between the first discharge-scanning acts, the controller 90 controls the conveyer 50 to convey the sheet 1 by the distance, which is equal to the distance of separation between two of the nozzles N located on one end and the other end in the sub-scanning direction among the nozzles N forming the nozzle row NR.

In the distributing process, the image data pieces K1-K4 (see FIG. 6) corresponding to four consecutive pixels adjacent in the sub-scanning direction are distributively assigned to four nozzles N1-N4 (see FIG. 1) in the four nozzle rows NR1-NR4 aligned along the main scanning direction, respectively. The distributing process is executed to every four image data pieces K1-K4 corresponding to four consecutive pixels in the image data to be distributed to the four nozzles N1-N4 in the four nozzle rows NR1-NR4 aligned along the main scanning direction. Thereafter, in the second discharge-scan acts, the ink in the small droplet size is discharged from the nozzles N that form the nozzle rows NR1-NR4 in the head 10.

Moreover, in the second discharge-scanning act, while the head 10 moves with respect to the sheet 1 in the forward-scanning direction or the backward scanning direction, when the nozzle N1 comes to a position to face a predetermined position on the sheet 1, the ink is discharged at the sheet 1 from the nozzle N1, and when the other nozzles N2-N4 come to the position to face the same predetermined position on the sheet 1 one after another, the ink is discharged at the sheet 1 from the nozzles N2-N4, respectively. In other words, the ink may be discharged from the four nozzles N1-N4 at the timings when each of the nozzles N1-N4 comes to the same position with respect to the sheet 1. Thus, the controller 90 controls the head 10 to discharge the ink in droplets, which correspond to the image data pieces K1-K4 assigned to the nozzles N1-N4, respectively, from the nozzles N1-N4. In the second discharge-scanning act, the ink is discharged from all of the nozzles N, to which the image data pieces K1-K4 corresponding to the pixels are assigned. Thereby, the image may be formed on the sheet 1.

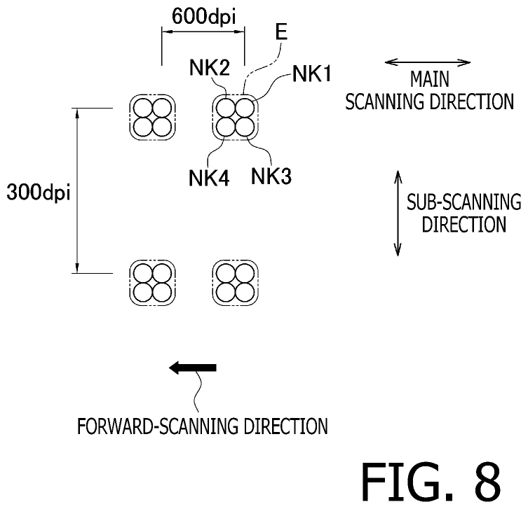

While the ink may be discharged from the nozzles N1-N4 at the timings when each of the nozzles N1-N4 is at the same position with respect to the sheet 1 within the single printing cycle, there may be cases such that the droplets of the ink land in the same position on the sheet 1 without deviating and such that the droplets of the ink land to overlap one another rather partly. Moreover, there may be a case such that the droplets of the ink land in positions deviated from one another without overlapping. In other words, as shown in FIG. 8, dots NK1-NK4 formed of the droplets of the ink discharged from the four nozzles N1-N4 on the sheet 1 are all located within a near range E, which includes a landing position where the ink from the nozzle N1 lands. The dots NK1-NK4 are dots formed according to the image data pieces K1-K4, respectively.

Moreover, in the second discharge-scanning act, the controller 90 controls the head 10 to discharge the ink from the nozzles N1, N2, N3, N4 in this given order when the head 10 moves in the forward-scanning direction and from the nozzles N4, N3, N2, N1 in this given order when the head 10 moves in the backward-scanning direction. Furthermore, the controller 90 controls the head 10 to discharge the ink from the nozzles N1-N4 in an arrangement such that, in one printing cycle, the timing to discharge the ink from any of the nozzles N1-N4 in the head 10 moving in the forward-scanning direction or the backward-scanning direction is synchronized to occur when the nozzle is at the same position with respect to the sheet 1 in the main scanning direction.

In either the first printing process or the second printing process, when the number of discharge-scanning acts reaches a number equal to or greater than a predetermined number, the controller 90 may execute a flushing process. In the flushing process, the controller 90 activates the driver IC 14 based on flushing data, which is different from the image data, to deform the actuators 13X to cause the ink to be discharged from the nozzles N. The nozzles N to be flushed in the flushing process are the nozzles N used to discharge the ink in the first or second printing process. The ink discharged in the flushing process is received by the receiver 60 and may be drawn to a waste ink tank, which is not shown.

In either the first printing process or the second printing process, when the image based on the first print data or the second print data is formed completely on the sheet 1, the sheet 1 is ejected, and the process ends.

As described above, according to the printing system 100, in the second discharge-scanning act, the ink discharged from the nozzles N2-N4 may land in the same position where the ink discharged from the nozzle N1 lands. Therefore, an amount of the ink landed in the position where the ink discharged from the nozzle N1 lands may increase. Accordingly, a size of a spot where the ink discharged from the four nozzles N1-N4 lands is larger than a size of a spot where the ink discharged from a single nozzle N lands. Moreover, the ink discharged from the nozzles N2-N4 may land on the sheet 1 in the range around the position where the ink discharged from the nozzle N1 lands. Accordingly, a size of a spot where the ink discharged from the four nozzles N1-N4 lands is larger than a size of a spot where the ink discharged from a single nozzle N lands. As a result, a quality of the image printed on the sheet 1 may be improved.

In the second printing process, while the ink may be discharged from the nozzles N in the small droplet size, in which the amount of the ink is smaller than the ink in the medium or large droplet size, the ink discharged from the nozzles N2-N4 may land in the near range E including the position where the ink discharged from the nozzle N1 lands. Therefore, compared to an image in which dots are each formed of a single droplet in the medium or large droplet size, the image in which the dots NK1-NK4 are each formed of four droplets in the small droplet size may have smaller gaps among the dots. Accordingly, a quality of the image printed on the sheet 1 may be improved. For example, in order to improve the quality of the image to be printed in the first printing process, ink in a droplet size larger than the large droplet size may be discharged. In such an arrangement, however, the printing cycle may need to be extended in order to reliably discharge the ink in the larger droplet size from the nozzles N. Therefore, a speed for printing the image may be lowered, and an amount of the ink to be consumed may be increased. On the other hand, according to the present embodiment, the amount of the ink to be consumed to print the image may be substantially equal to the amount of the ink to be consumed when the size of the droplet is large; therefore, the printing speed may be maintained or prevented from being lowered, and the quality of the image may be improved.

Moreover, the controller 90 distributes the image data pieces K1-K4 corresponding to four consecutive pixels adjacent in the sub-scanning direction to the four nozzles N1-N2 in the four nozzle rows NR1-NR4 aligned along the main scanning direction, respectively. In this arrangement, the ink may be distributively discharged from the four nozzles N1-N4 based on the four image data pieces K1-K4.

Moreover, in the second discharge-scanning act, the controller 90 may control the head 10 to discharge the ink at the sheet 1 from the four nozzles N1-N4 at the timings when each of the nozzles N1-N4 is located at the same position with respect to the sheet 1. Therefore, the ink discharged from the nozzles N2-N4 may land easily in or near the position where the ink discharged from the nozzle N1 lands.

### Second Embodiment

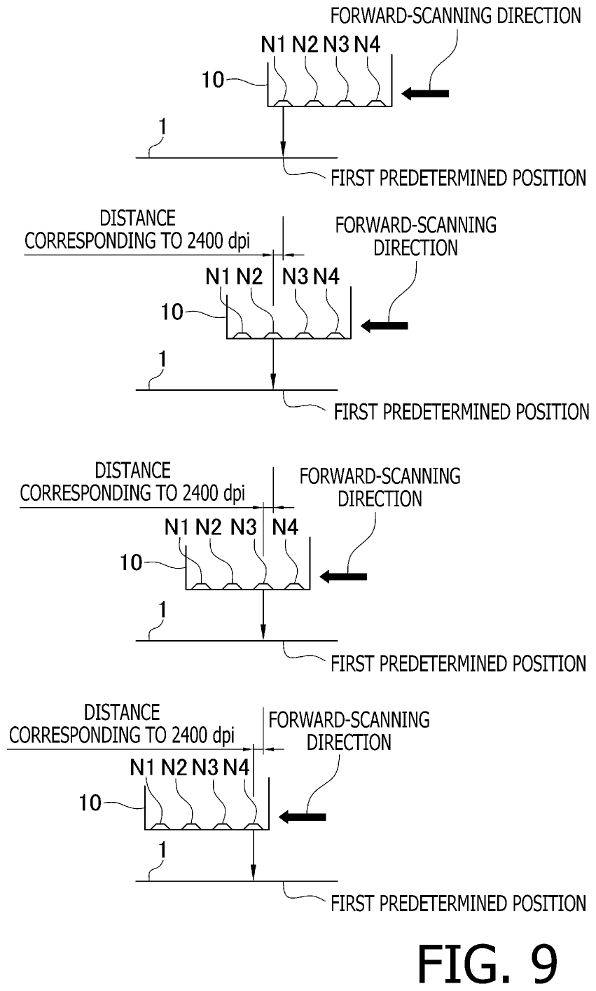

Next, a printing system 100 according to a second embodiment of the present disclosure will be described with reference to FIGS. 9-11.

According to the first embodiment described above, in the second discharge-scanning act, the ink is discharged at the same predetermined position on the sheet 1 from the nozzles N1-N4 when each of the nozzles N1-N4 is located at the same position with respect to the sheet 1. Meanwhile, in the second discharge-scanning act in the second embodiment, the controller 90 uses the image data in the second print data as described in the first embodiment and controls the head 10 to discharge the ink from the nozzles N1-N4 at different positions on the sheet 1 so that a resolution of the image in a direction corresponding to the main scanning direction is equal to a product of the printing resolution of the image to be printed on the sheet 1, i.e., 600 dpi, and the number of nozzle rows NR, i.e., 4.

In particular, as shown in FIG. 9, while the head 10 moves in the forward-scanning direction, the controller 90 controls the head 10 to discharge the ink at the sheet 1 from the nozzle N1 when the nozzle N1 is at a position to face a first predetermined position on the sheet 1, and when the nozzle N2 moving in the forward-scanning direction reaches a position apart from the first predetermined position on the sheet 1 by a distance corresponding to a printing resolution of 2400 dpi, the controller 90 controls the head 10 to discharge the ink from the nozzle N2. Further, when the nozzle N3 moving in the forward-scanning direction reaches a position apart from the first predetermined position on the sheet 1 by a distance corresponding to the printing resolution of 2400 dpi multiplied by 2, the controller 90 controls the head 10 to discharge the ink from the nozzle N3. Furthermore, when the nozzle N4 moving in the forward-scanning direction reaches a position apart from the first predetermined position on the sheet 1 by a distance corresponding to the printing resolution of 2400 dpi multiplied by 3, the controller 90 controls the head 10 to discharge the ink from the nozzle N4.

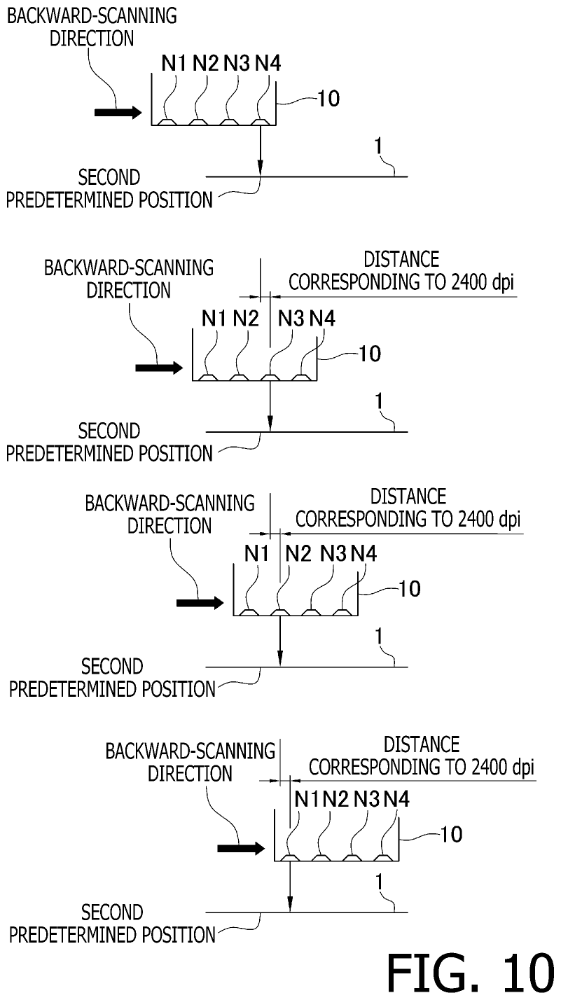

Moreover, as shown in FIG. 10, while the head 10 moves in the backward-scanning direction, the controller 90 controls the head 10 to discharge the ink at the sheet 1 from the nozzle N4 when the nozzle N4 is at a position to face a second predetermined position on the sheet 1, and when the nozzle N3 moving in the backward-scanning direction reaches a position apart from the second predetermined position on the sheet 1 by the distance corresponding to the printing resolution of 2400 dpi, the controller 90 controls the head 10 to discharge the ink from the nozzle N3. Further, when the nozzle N2 moving in the backward-scanning direction reaches a position apart from the second predetermined position on the sheet 1 by the distance corresponding to the printing resolution of 2400 dpi multiplied by 2, the controller 90 controls the head 10 to discharge the ink from the nozzle N2. Furthermore, when the nozzle N1 moving in the backward-scanning direction reaches a position apart from the second predetermined position on the sheet 1 by the distance corresponding to the printing resolution of 2400 dpi multiplied by 3, the controller 90 controls the head 10 to discharge the ink from the nozzle N1. The second predetermined position is the same position in the main scanning direction as the position on the sheet 1 at which the ink was discharged earlier from the nozzle N4 when the head 10 was moving in the forward-scanning direction. In other words, the second predetermined position overlaps in the sub-scanning direction the position on the sheet 1 at which the ink was discharged earlier from the nozzle N4 when the head 10 was moving in the forward-scanning direction.

In the second discharge-scanning act in the second embodiment, similarly to the second discharge-scanning act in the first embodiment, the controller 90 controls the head 10 to discharge the ink from the nozzles N1, N2, N3, N4 in this given order when the head 10 moves in the forward-scanning direction and from the nozzles N4, N3, N2, N1 in this given order when the head 10 moves in the backward-scanning direction. Furthermore, the controller 90 controls the head 10 to discharge the ink from each of the nozzles N1-N4 in the arrangement such that, in one printing cycle, the timing to discharge the ink from any of the nozzles N1-N4 in the head 10 moving in the forward-scanning direction or the backward-scanning direction is synchronized to occur when the nozzle is at the same position with respect to the sheet 1 in the main scanning direction. In other words, a position where the ink is discharged from each of the nozzles N1-N4 of the head 10 moving in the forward-scanning direction and a position where the ink is discharged from each of the nozzles N1-N4 of the head 10 moving in the backward-scanning direction are the same position with respect to the sheet 1 in the main scanning direction.

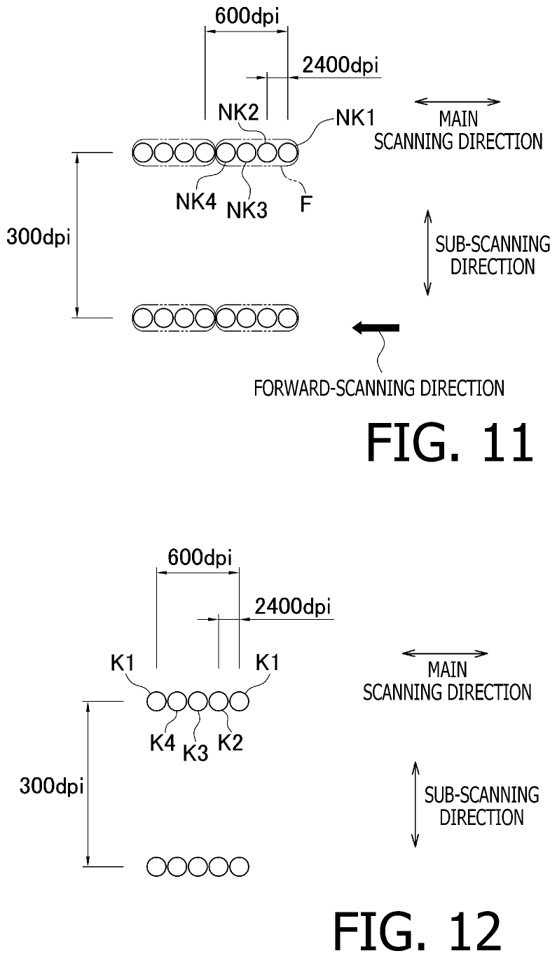

Thus, as shown in FIG. 11, the dots NK1-NK4 formed on the sheet 1 in the ink discharged from the four nozzles N1-N4 are located within a near range F including the position where the ink discharged from the nozzle N1 lands, and the resolution of 2400 dpi in the direction corresponding to the main scanning direction is achieved.

According to the printing system 100 in the second embodiment, in the second discharge-scanning act, the ink may be discharged from the nozzles N1-N4 based on the image data pieces K1-K4 which correspond to the four consecutive pixels adjacent in the sub-scanning direction, and the ink discharged from the nozzles N2-N4 may land in the range near the position where the ink discharged from the nozzle N1 landed. Accordingly, similarly to the first embodiment, a quality of the image printed on the sheet 1 may be improved. Moreover, the ink discharged from the nozzles N1-N4 may land in the different positions on the sheet 1 in the main scanning direction; therefore, a quality of the image in the main scanning direction may be improved.

In the second embodiment, the controller 90 controls the head 10 to discharge the ink from the nozzles N in the arrayed order of the nozzle rows NR, which conforms with the moving direction of the head 10. Therefore, in both cases when the head 10 moves in one way, e.g., the forward-scanning direction, and when the head 10 returns in the other way, e.g., the backward-scanning direction, the landing positions where the ink discharged from the nozzles N1-N4 land are aligned in line extending from one side toward the other side and from the other side toward the one side, respectively, along the main scanning direction. Accordingly, color difference or color unevenness, which may otherwise occur when the ink discharged from the nozzles N1-N4 land on the sheet 1 in different orders depending on the moving direction of the head 10 in the bidirectional scanning printing, may be prevented or reduced. Moreover, the controller 90 controls the head 10 to discharge the ink from the nozzles N1-N4 such that the timing to discharge the ink from any of the nozzles N1-N4 of the head 10 moving in the backward-scanning direction or the forward-scanning direction is synchronized to occur when the nozzle is located at the same position with respect to the sheet 1 in the main scanning direction. Accordingly, again, color difference or color unevenness, which may otherwise occur when the ink discharged from the nozzles N1-N4 land on the sheet 1 in different orders depending on the moving direction of the head 10 in the bidirectional scanning printing, may be prevented or reduced.

In the second embodiment, correspondence between the image data pieces K1-K4 and the nozzles N1-N4 in the distributing process may not necessarily be limited; however, the correspondence between the image data pieces K1-K4 and the nozzles N1-N4 may be fixed. For example, the controller 90 may assign the image data piece K1 to the nozzle N1, the image data piece K2 to the nozzle N2, the image data piece K3 to the nozzle N3, and the image data piece K4 to the nozzle N4 in the distributing process in either of the cases where the head 10 moves with respect to the sheet 1 in the forward-scanning direction and where the head 10 moves with respect to the sheet 1 in the backward-scanning direction. In other word, when the head 10 moves with respect to the sheet 1 in the forward-scanning direction, the controller 90 may assign the four consecutive image data pieces K1-K4 to the four nozzles N1-N4 in this given order, respectively, and when the head 10 moves with respect to the sheet 1 in the backward-scanning direction, the controller 90 may assign the four consecutive image data pieces K4-K1 to the four nozzles N4-N1 in this given order, respectively.

### Third Embodiment

Next, a printing system 100 according to a third embodiment of the present disclosure will be described with reference to FIG. 12.

In the first embodiment described above, in S4 (see FIG. 4), the controller 90 generates the image data for the second print data, in which the resolution of the image in the sub-scanning direction is equal to the printing resolution 300 dpi in the sub-scanning direction multiplied by 4 being the number of the nozzle rows NR having the nozzles N to discharge the ink. In the distributing process, the controller 90 assigns the image data pieces K1-K4 corresponding to four consecutive pixels adjacent in the sub-scanning direction to the nozzles N1-N4, respectively.

Meanwhile, in the third embodiment, in S4, the controller 90 generates the image data for the second print data, in which the resolution of the image in the main scanning direction is equal to the printing resolution 600 dpi in the main-scanning direction multiplied by the number of the nozzle rows NR having the nozzles N to discharge the ink. FIG. 12 illustrates the image data including a plurality of image data pieces to compose an image in the resolutions of 2400 dpi in the main scanning direction and 300 dpi in the sub-scanning direction. Circles in FIG. 12 each represent one of the image data pieces corresponding to a pixel to form the image being printed. In the distributing process, the controller 90 assigns the image data pieces K1-K4 corresponding to four consecutive pixels adjacent in the main scanning direction to the nozzles N1-N4, respectively. The distributing process is executed to every four image data pieces K1-K4 corresponding to four consecutive pixels in the image data to be distributed to the four nozzles N1-N4 in the four nozzle rows NR1-NR4 aligned along the main scanning direction.

In the second discharge-scanning act, while the head 10 moves with respect to the sheet 1 in the forward-scanning direction or the backward scanning direction, when the nozzle N1 comes to a position to face the predetermined position on the sheet 1, the ink is discharged at the sheet 1 from the nozzle N1, and when the other nozzles N2-N4 come to the position to face the same predetermined position on the sheet 1 one after another, the ink is discharged at the sheet 1 from the nozzles N2-N4, respectively. Thus, the controller 90 controls the head 10 to discharge the ink in droplets, which correspond to the image data pieces K1-K4 assigned to the nozzles N1-N4, respectively, from the nozzles N1-N4. In the second discharge-scanning act, the ink is discharged from all of the nozzles N, to which the image data pieces corresponding to the pixels are assigned.

According to the third embodiment, the ink is discharged from any of the nozzles N1-N4 at the same timing in one printing cycle when the nozzle is located at the same position with respect to the sheet 1. Therefore, similarly to the first embodiment described above, four dots NK1-NK4 (see FIG. 8) formed on the sheet 1 are all located within a near range E (see FIG. 8), which includes the landing position where the ink from the nozzle N1 lands.

According to the printing system 100 in the third embodiment, the benefits achievable by the first embodiment may be similarly achieved by the same or similar configuration in the third embodiment. Moreover, the controller 90 distributes the image data pieces K1-K4 corresponding to the four consecutive pixels adjacent in the main scanning direction to the four nozzles N1-N4 in the four nozzle rows NR aligned along the main scanning direction. Therefore, the ink may be discharged from the four nozzles N1-N4 based on the four image data pieces K1-K4.

While the invention has been described in conjunction with various example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

For example, the first print data and the second print data may not necessarily be generated by the controller 103 in the external device 102 but may be generated and received by the controller 90 in the printer 101 alone, and the controller 90 may execute the first and second printing processes. In other words, the printing system 100 may consist of the printer 101 alone. For another example, whether the first print data is to be generated and the first printing process is to be executed or the second print data is to be generated and the second printing process is to be executed may not necessarily be determined by the printing mode, which may be one of the high-quality mode and the regular mode, but may be determined by speed of the printer 101 to receive data from the external device 102. In other words, if a communication rate between the external device 102 and the printer 101 is higher than a threshold rate, the controller 90 may generate the second print data and execute the second printing process, and if the communication rate between the external device 102 and the printer 101 is equal to or lower than the threshold rate, the controller 90 may generate the first print data and execute the first printing process. In this arrangement, when the communication rate between the external device 102 and the printer 101 is higher, in other words, when the printer 101 is capable of receiving the print data having a larger volume from the external device 102 in shorter time, an image in the high quality may be achieved. On the other hand, when the communication rate between the external device 102 and the printer 101 is lower, in other words, when the printer 101 may not be able to receive the print data in the larger volume while the printer 101 may be capable of printing images in a speed faster than the receiving rate, the controller 90 in the printer 101 may receive the first print data having a smaller volume from the external device 102 to complete receiving of the print data and printing the image based on the received print data smoothly. Accordingly, a situation such that the print data is not received fast enough compared to the printing speed due to the large volume of the print data may be prevented.

For another example, the number of the nozzle rows NR in the head 10 may not necessarily be limited to four but may be two, three, five, or more. For another example, the nozzle rows NR1-NR4 may not necessarily be arrayed at the equal intervals in the main scanning direction. If the nozzle rows NR1-NR4 are not arrayed at the equal intervals in the main scanning direction, the head 10 may be controlled to discharge the ink from the nozzles N in the nozzle rows NR1-NR4 at timings in conformity with the predetermined printing resolution in the main scanning direction for printing an image. For another example, in the second printing process, the ink may not necessarily be discharged from all of the nozzles N that form the nozzle rows NR based on the image data but may be discharged only from some of the nozzles N that form the nozzle rows NR. For another example, two or more nozzle rows NR may be selected to be used in the second discharge-scanning act among the plurality of nozzle rows NR, and the ink may be discharged from the nozzles N that form the selected nozzle rows NR.

For another example, the size of the droplets of the ink to be discharged from the nozzles N in the second printing process in the first embodiment may not necessarily be limited to small, but a different size of droplets of the ink may be discharged from the nozzles N. For another example, the size of the droplets to be discharged from the nozzles N may be fixed to a single size. For another example, the amounts of the ink to be discharged from the nozzles N in the first printing process and the second printing process may not necessarily be differentiated by the size of the droplets of the ink as long as an amount of the ink to be discharged from each nozzle N in the second printing process is smaller than an amount of the ink to be discharged from each nozzle N in the first printing process.

For another example, in the embodiments and the modified examples described above, the first printing process may not necessarily be executed. In other words, the printing system 100 may always print images in the second printing process. In this arrangement, images in the higher quality may be achieved all time.

For another example, in the second discharge-scanning act, the controller 90 may not necessarily control the head 10 to discharge the ink from the nozzles N1-N4 in this given order when the head 10 moves in the forward-scanning direction or from the nozzles N4-N1 in this given order when the head 10 moves in the backward scanning direction. For another example, in the second discharge-scanning act, the ink may not necessarily be discharged from each of the nozzles N1-N4 such that the timing in each printing cycle to discharge the ink from each of the nozzles N1-N4 of the head 10 moving in the forward-scanning direction and the timing in each printing cycle to discharge the ink from each of the nozzles N1-N4 of the head 10 moving in the backward-scanning direction are the same, but the ink may be discharged at different timings when the nozzles N1-N4 are at different relative positions with respect to the sheet 1 in the main scanning direction.

For another example, the head 10 may not necessarily be limited to the serial head but may be a line head, which may be fixed steadily without moving in the direction intersecting with the conveying direction to convey the sheet 1. In this arrangement, the line head may have a plurality of nozzle rows consisting of a plurality of nozzles aligned in the direction intersecting with the conveying direction. Moreover, the plurality of nozzle rows may be arrayed along the conveying direction. The conveyer may move the sheet 1 relatively to the head in the sub-scanning direction. In other words, the head may move relatively to the sheet 1 in the second direction. In this arrangement, the head may have the plurality of nozzle rows NR1-NR4 arrayed along the sub-scanning direction, and the nozzle rows NR1-NR4 may include nozzles N1-N4, respectively, which are located at positions to overlap one another in the sub-scanning direction. While the line head moves with respect to the sheet 1 in the sub-scanning direction, when the nozzle N1 comes to a position to face a predetermined position on the sheet 1, the ink may be discharged at the sheet 1 from the nozzle N1, and when the other nozzles N2-N4 come to the position to face the same predetermined position on the sheet one after another, the ink may be discharged at the sheet 1 from the nozzles N2-N4, respectively. In other words, the ink may be discharged from the four nozzles N1-N4 at the timings when each of the nozzles N1-N4 comes to the same position with respect to the sheet 1. The dots NK1-NK4 formed of the ink droplets discharged from the four nozzles N1-N4 may all land in the near range E including the position where the ink discharged from the nozzle N1 lands, substantially equally to the dots NK1-NK4 shown in FIG. 8. With the printer having this type of line head, the benefits achievable from the printer 101 described above may be similarly achieved.

For another example, the present disclosure may not necessarily be applicable only to a printer as described above but may be applicable to, for example, a facsimile machine, a copier, and a multifunction peripheral machine. Moreover, the present disclosure may be applied to a liquid discharging apparatus usable in a purpose other than image recording, such as, for example, a liquid discharging apparatus to discharge conductive liquid to form conductive patterns on a substrate. For another example, a material of the medium onto which the liquid is discharged may not necessarily be limited to paper but may be, for example, fabric, substrate, etc., or may be a recording medium not necessarily in the form of sheet. For another example, the liquid to be discharged through the nozzles N may not limited to ink but may be another type of liquid such as, for example, a processing solution that may coagulate or precipitate the components in ink, as long as the liquid of the same type is dischargeable from all of the nozzles N.

What is claimed is:

1. A liquid discharging system, comprising:
a head including a first nozzle row and a second nozzle row, the first nozzle row having a plurality of nozzles including a first nozzle aligned in a first direction, the second nozzle row having a plurality of nozzles including a second nozzle aligned in the first direction, the first nozzle row and the second nozzle row being arrayed along a second direction, the second direction intersecting with the first direction, the first nozzle and the second nozzle being located at positions to overlap each other in the second direction; and
a controller system configured to control the head to discharge liquid of the same type from the first nozzle and the second nozzle at a recording medium when the first nozzle and the second nozzle are each located at the same position with respect to the recording medium while the head moves in the second direction relatively to the recording medium.

2. The liquid discharging system according to claim 1, wherein
the controller system is configured to control the head to discharge selectively one of a first amount of the liquid and a second amount of the liquid from the first nozzle and the second nozzle, the second amount being smaller than the first amount, and
when the first nozzle and the second nozzle are each located at the same position with respect to the recording medium while the head moves in the second direction relatively to the recording medium, the controller system is configured to control the head to discharge the second amount of the liquid from each of the first nozzle and the second nozzle at the recording medium.

3. The liquid discharging system according to claim 1, wherein
the controller system is configured to receive image data including image data pieces to compose an image, of which resolution corresponding to a third direction intersecting with the second direction is equal to a product of a resolution of an image to be printed on the recording medium and the number of nozzle rows in the head having nozzles to discharge the liquid at the recording medium when the nozzles are each located at the same position with respect to the recording medium,
the controller system is configured to distribute two image data pieces adjacent in the third direction among the image data pieces in the image data to the first nozzle and the second nozzle, and
the controller system is configured to control the head to discharge the liquid from the first nozzle and the second nozzle according to the two image data pieces distributed to the first nozzle and the second nozzle.

4. The liquid discharging system according to claim 1, wherein
the controller system is configured to receive image data including image data pieces to compose an image, of which resolution corresponding to the second direction is equal to a product of a resolution of an image to be printed on the recording medium and the number of nozzle rows in the head having nozzles to discharge the liquid at the recording medium when the nozzles are each located at the same position with respect to the recording medium,
the controller system is configured to distribute two image data pieces adjacent in the second direction among the image data pieces in the image data to the first nozzle and the second nozzle, and
the controller system is configured to control the head to discharge the liquid from the first nozzle and the second nozzle according to the two image data pieces distributed to the first nozzle and the second nozzle.

5. The liquid discharging system according to claim 1, further comprising a movable assembly configured to move the head in the second direction.

6. The liquid discharging system according to claim 1, further comprising a liquid discharging apparatus, the liquid discharging apparatus including the head,
wherein the controller system is included in the liquid discharging apparatus.

7. A liquid discharging system, comprising:
a head including a first nozzle row and a second nozzle row, the first nozzle row having a plurality of nozzles including a first nozzle aligned in a first direction, the second nozzle row having a plurality of nozzles including a second nozzle aligned in the first direction, the first nozzle row and the second nozzle row being arrayed along a second direction, the second direction intersecting with the first direction, the first nozzle and the second nozzle being located at positions to overlap each other in the second direction; and
a controller system configured to:
receive image data including image data pieces to compose an image, of which resolution corresponding to a third direction intersecting with the second direction is equal to a product of a resolution of an image to be printed on a recording medium and the number of the nozzle rows in the head;
distribute two image data pieces adjacent in the third direction among the image data pieces in the image data to the first nozzle and the second nozzle; and
control the head to discharge liquid of the same type at the recording medium from the first nozzle according to one of the two image data pieces assigned to the first nozzle and from the second nozzle according to the other of the two image data pieces assigned to the second nozzle while the head moves in the second direction relatively to the recording medium.

8. The liquid discharging system according to claim 7, wherein the controller system is configured to control the head to discharge the liquid from the first nozzle and the second nozzle at the recording medium when the first nozzle and the second nozzle are each located at the same position with respect to the recording medium while the head moves in the second direction relatively to the recording medium.

9. The liquid discharging system according to claim 7, wherein the controller system is configured to control the head to discharge the liquid at different positions on the recording medium from the first nozzle and the second nozzle to compose an image, of which resolution corresponding to the second direction is equal to a product of a resolution of an image to be printed on the recording medium and the number of the nozzle rows in the head.

10. The liquid discharging system according to claim 9, further comprising a movable assembly configured to move the head in one way and the other way along the second direction,
wherein the controller system is configured to control the head to discharge the liquid from the first nozzle and the second nozzle in this given order when the movable assembly moves the head in the one way along the second direction and from the second nozzle and the first nozzle in this given order when the movable assembly moves the head in the other way along the second direction.

11. The liquid discharging system according to claim 10, wherein
the controller system is configured to control the head to discharge the liquid at the recording medium in an arrangement such that a position where the liquid is to be discharged from the first nozzle when the movable assembly moves the head in the one way along the second direction and a position where the liquid is to be discharged from the first nozzle when the movable assembly moves the head in the other way along the second direction are the same position with respect to the recording medium.

12. The liquid discharging system according to claim 9, further comprising a movable assembly configured to move the head in one way and the other way along the second direction,
wherein, for acts each by the movable assembly to move the head in the one way and in the other way along the second direction, the controller system is configured to assign one of the two image data pieces adjacent in the third direction to the first nozzle and the other of the two image data pieces adjacent in the third direction to the second nozzle.

13. The liquid discharging system according to claim 7, further comprising
a liquid discharging apparatus, the liquid discharging apparatus including the head,
wherein the controller system is included in the liquid discharging apparatus.

14. The liquid discharging system according to claim 7, further comprising a movable assembly configured to move the head in the second direction.
